(19) United States
(12) Patent Application Publication
(10) Pub. No.: US 2004/0193668 A1
(43) Pub. Date: Sep. 30, 2004

(54) Virtual double width accumulators for vector processing

(76) Inventors: Patrick Devaney, Haverhill, MA (US); David M. Keaton, Boulder, CO (US); Katsumi Murai, Moriguchi-City (JP)

Correspondence Address: RATNERPRESTIA, P O BOX 980, VALLEY FORGE, PA, 19482-0980, US

(21) Appl. No.: 10/403,315

(22) Filed: Mar. 31, 2003

(51) Int. Cl. G06F 7/38

(52) U.S. Cl. 708/523

(57) ABSTRACT

A processing system includes left and right data path processors configured to concurrently receive parallel instructions. Left and right accumulators which are, respectively, disposed in the left and right data path processors, are configured to execute an accumulate instruction and obtain an accumulation value. Left and right local memories (LMs) are coupled to the left and right accumulators and configured to store the accumulation value. The accumulation value is equally divided for storage in the left LM and the right LM.

### TECHNICAL FIELD

The present invention relates, in general, to computer architecture and, more specifically, to accumulators implemented in microprocessor based systems having sub-word parallel (SWP) processing capabilities.

### BACKGROUND OF THE INVENTION

When two integer numbers with N bit precision are multiplied, the result has 2N bit precision. For most applications, sufficient precision may be maintained by reducing the precision of the result back to N bits, so that the result precision is identical to the source precision. If a result is less than 2^{N}, the lowest N bits may be selected as the result with no loss of precision. If the result is greater than 2^{N}, however, the most significant N bits may be selected and shifted into a result register. There is some loss of precision in this case.

Precision loss is most important when results of several multiplications are being accumulated. The problem is magnified when SWP data is being accumulated. When SWP data are being accumulated more than N bits of intermediate precision must be retained during the accumulation, for the result to be accurate. Rounding down to N bits may occur only after the accumulation is completed. A typical choice for accumulation precision is 2N bits, although sometimes 3N may be used.

Conventionally, a single 2N bit accumulator register is used to double the precision during a partial or intermediate accumulation. After the intermediate accumulation, the 2N bit result is shifted/rounded and moved to a N bit register. Using a single accumulator register, however, creates a bottleneck in the register architecture, and introduces dead time to swap partial results when multiple accumulations are in progress simultaneously.

An example of an accumulation function implemented in a SWP processing system is disclosed in U.S. Pat. No. 5,918,062, issued Jun. 29, 1999. The patent describes vector instructions performing arithmetic operations using multiple input registers. An accumulate vector instruction is executed by adding together all input values within a single input register.

Vector instructions operate on operands that are partitioned into separate sections or sub-words. For example, a vector add instruction may include a pair of 32 bit operands, each of which is partitioned into four 8 bit sub-words. Upon execution of such a vector add instruction, corresponding 8 bit sub-words of each operand are independently and concurrently added to obtain four separate and independent addition results. An accumulate instruction, as another example, may include adding multiple product calculations, or sum-of-product calculations, which are part of a matrix multiply operation commonly used in multimedia applications.

Another example of a microprocessor with a single accumulator register is disclosed in U.S. Pat. No. 5,870,581, issued Feb. 9, 1999. The patent describes a register file multiplexed with a only one separate accumulator register. The accumulator register is connected in parallel with the register file to allow write operations to be performed concurrently during a single clock cycle. A clock cycle is an interval of time during which pipeline stages of a microprocessor perform their intended functions. At the end of the clock cycle, the resulting values are moved to the next pipeline stage. The accumulation during the clock cycle, however, is performed using only one accumulator.

The scalable processor architecture (SPARC) version 8 (V8) multiplies two N bit numbers to produce a 2N bit result by storing N bits in a general purpose register (GPR) and the other N bits in a special register, known as an ancillary Y register. The data stored in the Y register are then read into a normal GPR and used in a multiple precision calculation.

An issue occurring during multiplication of packed, data in SWP processing is how to store results of multiplied packed data. As an example, FIG. 8 shows two data sources in packed format, namely A₁₅₋₀ and B₁₅₋₀ (e.g. a 16×2 packed format). After multiplication, the result produces 32 bits. The result may be stored in an unpacked format or in a packed format. The unpacked format produces two separate 32 bit values. The packed format produces two separate 16×2 packed formats, as shown in FIG. 8. Packed format preserves the possibility of ignoring the high-words to produce single precision results directly, as in the SPARC Y register.

An embodiment of the present invention addresses a double width accumulator in a SWP processor, in which register pairs may store and re-load partial results of a double width accumulation.

### SUMMARY OF THE INVENTION

To meet this and other needs, and in view of its purposes, the present invention provides a processing system including left and right data path processors configured to concurrently receive parallel instructions. Left and right accumulators which are, respectively, disposed in the left and right data path processors, are configured to execute an accumulate instruction and obtain an accumulation value. Left and right local memories (LMs) are coupled to the left and right accumulators and configured to store the accumulation value. The accumulation value is equally divided for storage in the left LM and the right LM.

In an embodiment of the invention, the accumulation value includes a first value obtained by the left accumulator and a second value obtained by the right accumulator, and the first value is divided for storage in both the left LM and the right LM, and the second value is divided for storage in both the left LM and the right LM.

The invention includes a method of accumulating data in a processing system. The method has the steps of: (a) concurrently receiving parallel instructions; (b) obtaining an accumulation value in an accumulator in response to the received parallel instructions; (c) dividing the accumulation value into a first value and a second value; and (d) concurrently storing the first value in a left local memory (LM) and the second value in a right LM.

The method may also include the step of: (e) returning both the stored first value in the left LM and the stored second value in the right LM to the accumulator to obtain another accumulation value. The method may further include the step of: (f) delivering a result value of an executed instruction to the accumulator; and returning both the stored first value and the stored second value to the accumulator concurrently with delivering the result value in step (f) to obtain the other accumulation value.

Another embodiment of the invention is a method in a processing system including left and right data path processors sharing an internal register file, and left and right external local memories. The method accumulates data including the steps of: (a) fetching and storing an operand into an operand latch; (b) fetching and storing a partial accumulation value into an accumulation latch; (c) delivering the operand from the operand latch into the left data path processor and the right data path processor; (d) executing an operation using the delivered operand to obtain a result; (e) delivering the partial accumulation value into the left data path processor and the right data path processor; and (f) concurrently executing a left accumulation in the left data path processor and a right accumulation in the right data path processor using the result obtained in step (d) and the partial accumulation value delivered in step (e).

The method may also include the steps of: (g) after executing step (f), dividing a left accumulation value produced by the left accumulator into left high and low bits, and dividing a right accumulation value produced by the right accumulator into right high and low bits; and (h) writing back the left high bits and the right high bits, respectively, into the left external local memory, and writing back the left low bits and the right low bits, respectively, into the right external memory.

In an embodiment of the invention, step (h) includes writing back the left and right, high and low bits, respectively, into the left and right external local memories in the same one clock cycle. In another embodiment, step (h) includes writing back the left high and low bits into the external local memories in two clock cycles, and writing back the right high and low bits into the external local memories in the same two clock cycles.

It is understood that the foregoing general description and the following detailed description are exemplary, but are not restrictive, of the invention.

### BRIEF DESCRIPTION OF THE DRAWING

The invention is best understood from the following detailed description when read in connection with the accompanying drawing. Included in the drawing are the following figures:

FIG. 1 is a block diagram of a central processing unit (CPU), showing a left data path processor and a right data path processor incorporating an embodiment of the invention;

FIG. 2 is a block diagram of the CPU of FIG. 1 showing in detail the left data path processor and the right data path processor, each processor communicating with a register file, a local memory, a first-in-first-out (FIFO) system and a main memory, in accordance with an embodiment of the invention;

FIG. 3 is a block diagram of a multiprocessor system including multiple CPUs of FIG. 1 showing a processor core (left and right data path processors) communicating with left and right external local memories, a main memory and a FIFO system, in accordance with an embodiment of the invention;

FIG. 4 is a schematic block diagram of a virtual double width accumulator, used to produce double precision results in the CPU of FIG. 1, showing data formats and routing for a vector multiply and accumulate instruction, in accordance with an embodiment of the invention;

FIG. 5 is a schematic block diagram of an accumulator, pictorially arranged to show the stages or clock cycles for loading/storing data, respectively, between left and right local memories and left and right data path processors, in accordance with an embodiment of the invention;

FIG. 6 is a schematic block diagram of an accumulator, pictorially arranged to show the stages or clock cycles for loading/storing data, respectively, between left and right local memories and left and right data path processors, in accordance with another embodiment of the invention;

FIG. 7 is a schematic block diagram of an accumulator, pictorially arranged to show the stages or clock cycles for loading/storing data, respectively, between left and right local memories and left and right data path processors, in accordance with yet another embodiment of the invention; and

FIG. 8 is an example of two packed-format data sources multiplied to produce a result, which may be stored in packed-format or unpacked-format.

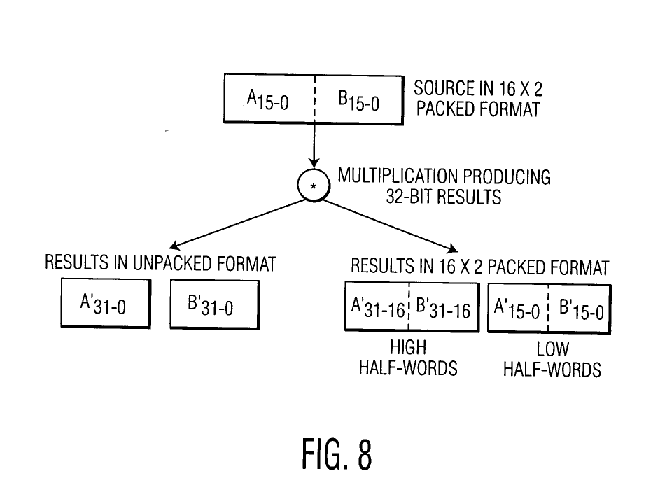

### DETAILED DESCRIPTION OF THE INVENTION

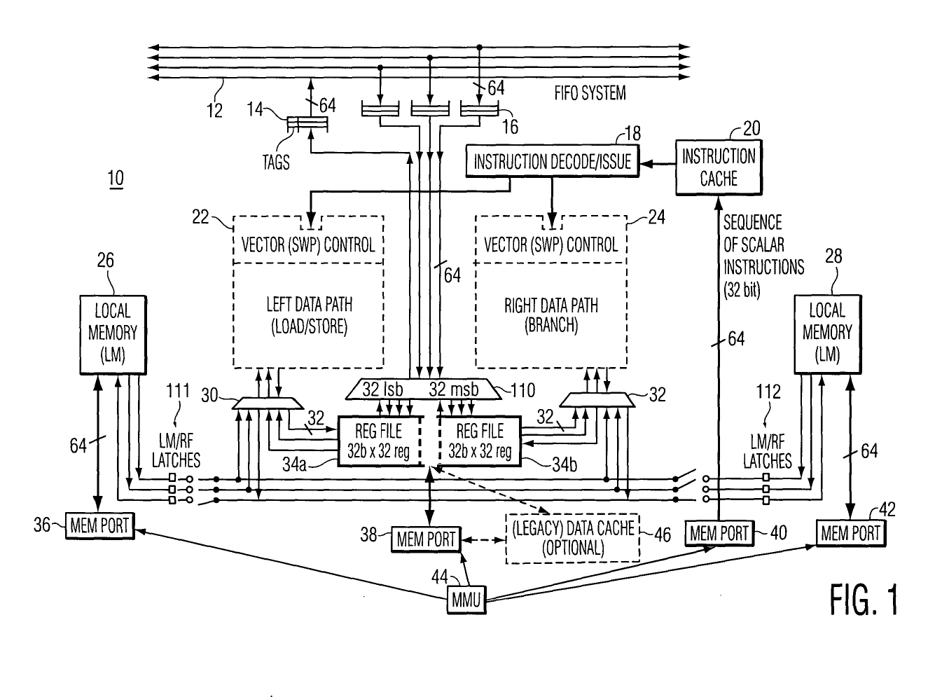

Referring to FIG. 1, there is shown a block diagram of a central processing unit (CPU), generally designated as 10. CPU 10 is a two-issue-super-scalar (2i-SS) instruction processor-core capable of executing multiple scalar instructions simultaneously or executing one vector instruction. A left data path processor, generally designated as 22, and a right data path processor, generally designated as 24, receive scalar or vector instructions from instruction decoder 18.

Instruction cache 20 stores read-out instructions, received from memory port 40 (accessing main memory), and provides them to instruction decoder 18. The instructions are decoded by decoder 18, which generates signals for the execution of each instruction, for example signals for controlling sub-word parallelism (SWP) within processors 22 and 24 and signals for transferring the contents of fields of the instruction to other circuits within these processors.

CPU 10 includes an internal register file which, when executing multiple scalar instructions, is treated as two separate register files 34a and 34b, each containing 32 registers, each having 32 bits. This internal register file, when executing a vector instruction, is treated as 32 registers, each having 64 bits. Register file 34 has four 32-bit read and two write (4R/2W) ports. Physically, the register file is 64 bits wide, but it is split into two 32-bit files when processing scalar instructions.

When processing multiple scalar instructions, two 32-bit wide instructions may be issued in each clock cycle. Two 32-bit wide data may be read from register file 32 from left data path processor 22 and right data path processor 24, by way of multiplexers 30 and 32. Conversely, 32-bit wide data may be written to register file 32 from left data path processor 22 and right data path processor 24, by way of multiplexers 30 and 32. When processing one vector instruction, the left and right 32 bit register files and read/write ports are joined together to create a single 64-bit register file that has two 64-bit read ports and one write port (2R/1W).

CPU 10 includes a level-one local memory (LM) that is externally located of the core-processor and is split into two halves, namely left LM 26 and right LM 28. There is one clock latency to move data between processors 22, 24 and left and right LMs 26, 28. Like register file 34, LM 26 and 28 are each physically 64 bits wide.

It will be appreciated that in the 2i-SS programming model, as implemented in the Sparc architecture, two 32-bit wide instructions are consumed per clock. It may read and write to the local memory with a latency of one clock, which is done via load and store instructions, with the LM given an address in high memory. The 2i-SS model may also issue pre-fetching loads to the LM. The SPARC ISA has no instructions or operands for LM. Accordingly, the LM is treated as memory, and accessed by load and store instructions. When vector instructions are issued, on the other hand, their operands may come from either the LM or the register file (RF). Thus, up to two 64-bit data may be read from the register file, using both multiplexers (30 and 32) working in a coordinated manner. Moreover, one 64 bit datum may also be written back to the register file. One superscalar instruction to one datapath may move a maximum of 32 bits of data, either from the LM to the RF (a load instruction) or from the RF to the LM (a store instruction).

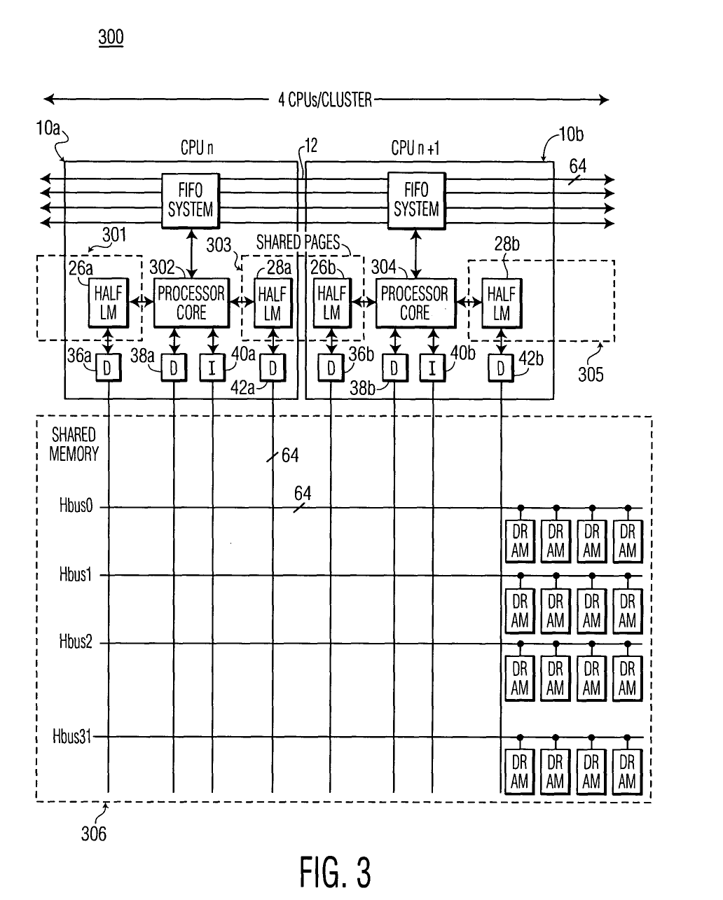

Four memory ports for accessing a level-two main memory of dynamic random access memory (DRAM) (as shown in FIG. 3) are included in CPU 10. Memory port 36 provides 64-bit data to or from left LM 26. Memory port 38 provides 64-bit data to or from register file 34, and memory port 42 provides data to or from right LM 28. 64-bit instruction data is provided to instruction cache 20 by way of memory port 40. Memory management unit (MMU) 44 controls loading and storing of data between each memory port and the DRAM. An optional level-one data cache, such as SPARC legacy data cache 46, may be accessed by CPU 10. In case of a cache miss, this cache is updated by way of memory port 38 which makes use of MMU 44.

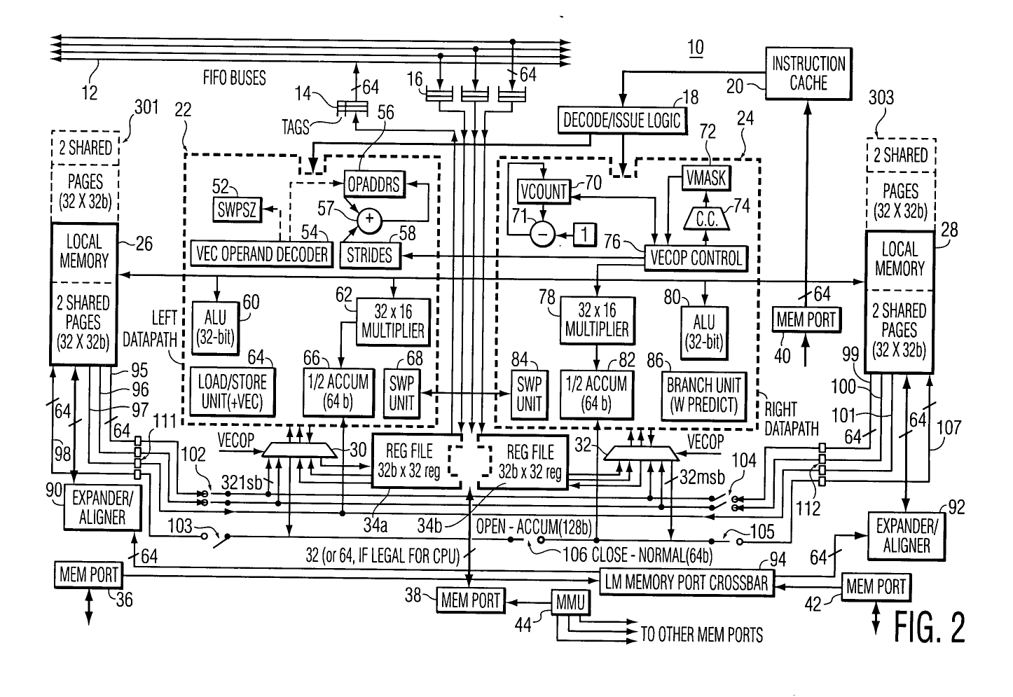

CPU 10 may issue two kinds of instructions: scalar and vector. Using instruction level parallelism (ILP), two independent scalar instructions may be issued to left data path processor 22 and right data path processor 24 by way of memory port 40. In scalar instructions, operands may be delivered from register file 34 and load/store instructions may move 32-bit data from/to the two LMs. In vector instructions, combinations of two separate instructions define a single vector instruction, which may be issued to both data paths under control of a vector control unit (as shown in FIG. 2). In vector instruction, operands may be delivered from the LMs and/or register file 34. Each scalar instruction processes 32 bits of data, whereas each vector instruction may process N×64 bits (where N is the vector length).

CPU 10 includes a first-in first-out (FIFO) buffer system having output buffer FIFO 14 and three input buffer FIFOs 16. The FIFO buffer system couples CPU 10 to neighboring CPUs (as shown in FIG. 3) of a multiprocessor system by way of multiple busses 12. The FIFO buffer system may be used to chain consecutive vector operands in a pipeline manner. The FIFO buffer system may transfer 32-bit or 64-bit instructions/operands from CPU 10 to its neighboring CPUs. The 32-bit or 64-bit data may be transferred by way of bus splitter 110.

Referring next to FIG. 2, CPU 10 is shown in greater detail. Left data path processor 22 includes arithmetic logic unit (ALU) 60, half multiplier 62, half accumulator 66 and sub-word processing (SWP) unit 68. Similarly, right data path processor 24 includes ALU 80, half multiplier 78, half accumulator 82 and SWP unit 84. ALU 60, 80 may each operate on 32 bits of data and half multiplier 62, 78 may each multiply 32 bits by 16 bits, or 2×16 bits by 16 bits. Half accumulator 66, 82 may each accumulate 64 bits of data and SWP unit 68, 84 may each process 8 bit, 16 bit or 32 bit quantities.

Non-symmetrical features in left and right data path processors include load/store unit 64 in left data path processor 22 and branch unit 86 in right data path processor 24. With a two-issue super scalar instruction, for example, provided from instruction decoder 18, the left data path processor includes instruction to the load/store unit for controlling read/write operations from/to memory, and the right data path processor includes instructions to the branch unit for branching with prediction. Accordingly, load/store instructions may be provided only to the left data path processor, and branch instructions may be provided only to the right data path processor.

For vector instructions, some processing activities are controlled in the left data path processor and some other processing activities are controlled in the right data path processor. As shown, left data path processor 22 includes vector operand decoder 54 for decoding source and destination addresses and storing the next memory addresses in operand address buffer 56. The current addresses in operand address buffer 56 are incremented by strides adder 57, which adds stride values stored in strides buffer 58 to the current addresses stored in operand address buffer 56.

It will be appreciated that vector data include vector elements stored in local memory at a predetermined address interval. This address interval is called a stride. Generally, there are various strides of vector data. If the stride of vector data is assumed to be “1”, then vector data elements are stored at consecutive storage addresses. If the stride is assumed to be “8”, then vector data elements are stored 8 locations apart (e.g. walking down a column of memory registers, instead of walking across a row of memory registers). The stride of vector data may take on other values, such as 2 or 4.

Vector operand decoder 54 also determines how to treat the 64 bits of data loaded from memory. The data may be treated as two-32 bit quantities, four-16 bit quantities or eight-8 bit quantities. The size of the data is stored in sub-word parallel size (SWPSZ) buffer 52.

The right data path processor includes vector operation (vecop) controller 76 for controlling each vector instruction. A condition code (CC) for each individual element of a vector is stored in cc buffer 74. A CC may include an overflow condition or a negative number condition, for example. The result of the CC may be placed in vector mask (Vmask) buffer 72.

It will be appreciated that vector processing reduces the frequency of branch instructions, since vector instructions themselves specify repetition of processing operations on different vector elements. For example, a single instruction may be processed up to 64 times (e.g. loop size of 64). The loop size of a vector instruction is stored in vector count (Vcount) buffer 70 and is automatically decremented by “1” via subtractor 71. Accordingly, one instruction may cause up to 64 individual vector element calculations and, when the Vcount buffer reaches a value of “0”, the vector instruction is completed. Each individual vector element calculation has its own CC.

It will also be appreciated that because of sub-word parallelism capability of CPU 10, as provided by SWPSZ buffer 52, one single vector instruction may process in parallel up to 8 sub-word data items of a 64 bit data item. Because the mask register contains only 64 entries, the maximum size of the vector is forced to create no more SWP elements than the 64 which may be handled by the mask register. It is possible to process, for example, up to 8×64 elements if the operation is not a CC operation, but then there may be potential for software-induced error. As a result, the invention limits the hardware to prevent such potential error.

Turning next to the internal register file and the external local memories, left data path processor 22 may load/store data from/to register file 34a and right data path processor 24 may load/store data from/to register file 34b, by way of multiplexers 30 and 32, respectively. Data may also be loaded/stored by each data path processor from/to LM 26 and LM 28, by way of multiplexers 30 and 32, respectively. During a vector instruction, two-64 bit source data may be loaded from LM 26 by way of busses 95, 96, when two source switches 102 are closed and two source switches 104 are opened. Each 64 bit source data may have its 32 least significant bits (LSB) loaded into left data path processor 22 and its 32 most significant bits (MSB) loaded into right data path processor 24. Similarly, two-64 bit source data may be loaded from LM 28 by way of busses 99, 100, when two source switches 104 are closed and two source switches 102 are opened.

Separate 64 bit source data may be loaded from LM 26 by way of bus 97 into half accumulators 66, 82 and, simultaneously, separate 64 bit source data may be loaded from LM 28 by way of bus 101 into half accumulators 66, 82. This provides the ability to preload a total of 128 bits into the two half accumulators.

Separate 64-bit destination data may be stored in LM 28 by way of bus 107, when destination switch 105 and normal/accumulate switch 106 are both closed and destination switch 103 is opened. The 32 LSB may be provided by left data path processor 22 and the 32 MSB may be provided by right data path processor 24. Similarly, separate 64-bit destination data may be stored in LM 26 by way of bus 98, when destination switch 103 and normal/accumulate switch 106 are both closed and destination switch 105 is opened. The load/store data from/to the LMs are buffered in left latches 111 and right latches 112, so that loading and storing may be performed in one clock cycle.

If normal/accumulate switch 106 is opened and destination switches 103 and 105 are both closed, 128 bits may be simultaneously written out from half accumulators 66, 82 in one clock cycle. 64 bits are written to LM 26 and the other 64 bits are simultaneously written to LM 28.

LM 26 may read/write 64 bit data from/to DRAM by way of LM memory port crossbar 94, which is coupled to memory port 36 and memory port 42. Similarly, LM 28 may read/write 64 bit data from/to DRAM. Register file 34 may access DRAM by way of memory port 38 and instruction cache 20 may access DRAM by way of memory port 40. MMU 44 controls memory ports 36, 38, 40 and 42.

Disposed between LM 26 and the DRAM is expander/aligner 90 and disposed between LM 28 and the DRAM is expander/aligner 92. Each expander/aligner may expand (duplicate) a word from DRAM and write it into an LM. For example, a word at address 3 of the DRAM may be duplicated and stored in LM addresses 0 and 1. In addition, each expander/aligner may take a word from the DRAM and properly align it in a LM. For example, the DRAM may deliver 64 bit items which are aligned to 64 bit boundaries. If a 32 bit item is desired to be delivered to the LM, the expander/aligner automatically aligns the delivered 32 bit item to 32 bit boundaries.

External LM 26 and LM 28 will now be described by referring to FIGS. 2 and 3. Each LM is physically disposed externally of and in between two CPUs in a multiprocessor system. As shown in FIG. 3, multiprocessor system 300 includes 4 CPUs per cluster (only two CPUs shown). CPUn is designated 10a and CPUn+1 is designated 10b. CPUn includes processor-core 302 and CPUn+1 includes processor-core 304. It will be appreciated that each processor-core includes a left data path processor (such as left data path processor 22) and a right data path processor (such as right data path processor 24).

A whole LM is disposed between two CPUs. For example, whole LM 301 is disposed between CPUn and CPUn−1 (not shown), whole LM 303 is disposed between CPUn and CPUn+1, and whole LM 305 is disposed between CPUn+1 and CPUn+2 (not shown). Each whole LM includes two half LMs. For example, whole LM 303 includes half LM 28a and half LM 26b. By partitioning the LMs in this manner, processor core 302 may load/store data from/to half LM 26a and half LM 28a. Similarly, processor core 304 may load/store data from/to half LM 26b and half LM 28b.

As shown in FIG. 2, whole LM 301 includes 4 pages, with each page having 32×32 bit registers. Processor core 302 (FIG. 3) may typically access half LM 26a on the left side of the core and half LM 28a on the right side of the core. Each half LM includes 2 pages. In this manner, processor core 302 and processor core 304 may each access a total of 4 pages of LM.

It will be appreciated, however, that if processor core 302 (for example) requires more than 4 pages of LM to execute a task, the operating system may assign to processor core 302 up to 4 pages of whole LM 301 on the left side and up to 4 pages of whole LM 303 on the right side. In this manner, CPUn may be assigned 8 pages of LM to execute a task, should the task so require.

Completing the description of FIG. 3, busses 12 of each FIFO system of CPUn and CPUn+1 corresponds to busses 12 shown in FIG. 2. Memory ports 36a, 38a, 40a and 42a of CPUn and memory ports 36b, 38b, 40b and 42b of CPUn+1 correspond, respectively, to memory ports 36, 38, 40 and 42 shown in FIG. 2. Each of these memory ports may access level-two memory 306 including a large crossbar, which may have, for example, 32 busses interfacing with a DRAM memory area. A DRAM page may be, for example, 32 K Bytes and there may be, for example, up to 128 pages per 4 CPUs in multiprocessor 300. The DRAM may include buffers plus sense-amplifiers to allow a next fetch operation to overlap a current read operation.

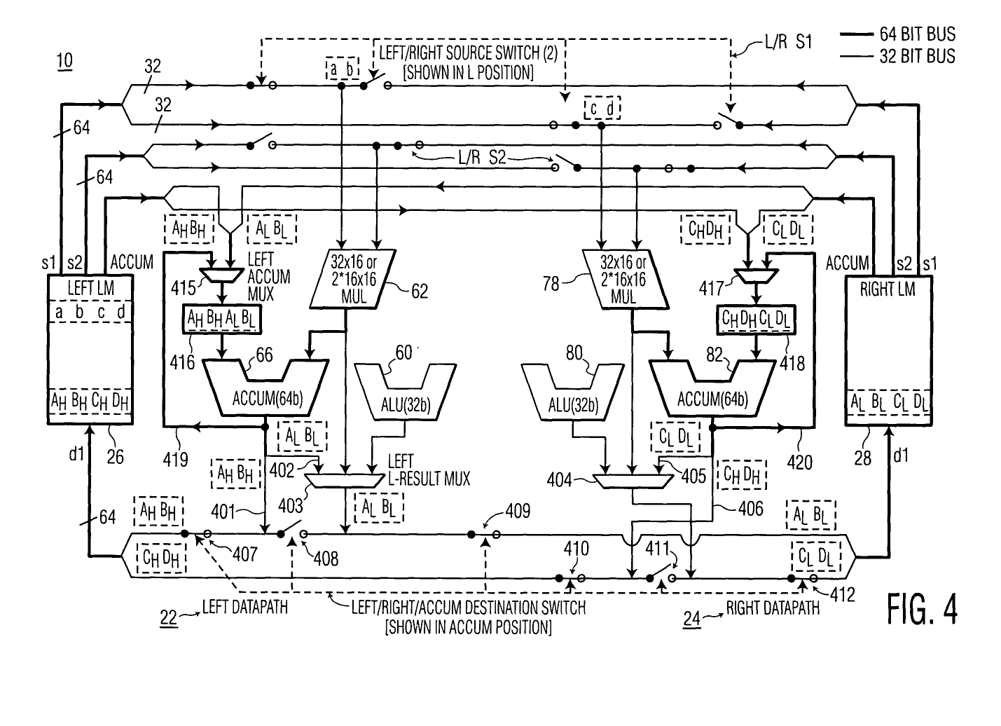

Referring next to FIG. 4, there is shown data formats and routing for a vector accumulation instruction using dual accumulators in CPU 10, in accordance with an embodiment of the invention. As shown, left data path processor 22 includes a dedicated half accumulator 66 (also referred to as left accumulator) and right data path processor 24 includes a dedicated half accumulator 82 (also referred to as right accumulator), each storing 64 bits.

System 10, as will be explained, may accumulate a double precision word, or a double width word of 128 bits, by splitting the accumulation between left data path processor 22 and right data path processor 24. This splitting, or dividing, of the accumulation assures that the burden of supplying the 128 bit accumulator operand is shared equally by the two physical LM banks of system 10. Left LM 26 and right LM 28, which are disposed externally of processors 22 and 24. The physically architected width of registers in the LM is 64 bits.

In the embodiment of the invention shown in FIG. 4, left LM 26 includes three read ports, namely source 1, source 2 and accumulator, each coupled to 64 bit busses, designated S1, S2 and accum. Left LM 26 includes a destination write port coupled to a 64 bit bus, designated d1. Similarly, right LM 28 includes three read ports and one write port.

For single precision vector operations (operations not using double width accumulation), 64 bit data are read (or loaded) from one half LM (left LM or right LM), split into two 32 bit data and delivered in parallel to left data path processor 22 and right data path processor 24. For example, left/right source switch (L/R S1) is shown in the left position, for splitting 64 bit data from source 1 of left LM 26 into two 32 bit data, and delivering them to multiplier 62 of the left data path processor and multiplier 78 of the right data path processor. The 64 bit source data are shown as four 16 bit data (a, b, c, d) packed into one 64 bit SWP word. Accordingly, a and b are delivered to multiplier 62 and c and d are delivered to multiplier 78.

Another vector operand (52) may be delivered from left LM 26 or right LM 28. In the embodiment of FIG. 4, source operand S2 is delivered from right LM 28, as a result of left/right source switch (L/R 52) placed, as show, in the right position. Half the data of source operand S2 is delivered to multiplier 62 and the other half is delivered to multiplier 78.

After multiplication, each multiplier produces a 64 bit word, which may be accumulated by left accumulator 66-and right accumulator 82. With single precision (64 bit word), storage space in a LM may be reserved for the low half of each accumulator only, and the routing for the high half, as well as the upper half of each 64 bit accumulator may be disabled. Accordingly, 32 bit data from left accumulator 66 and 32 bit data from right accumulator 82 may be delivered to left LM 26. Similarly, 32 bit data from left accumulator 66 and 32 bit data from right accumulator 82 may be delivered to right LM 28.

Thirty two bit data from left accumulator 66 may be delivered via 32 bit bus 401 to left LM 26 with destination switch 407 closed and destination switch 408 opened. Thirty two bit data from right accumulator 82 may be delivered via 32 bit bus 406 to left LM 26 with destination switch 410 closed and destination switch 411 opened. Similarly, 32 bit data from left accumulator 66 may be delivered via 32 bit bus 401 to right LM 28 with destination switch 407 opened, and destination switches 408 and 409 closed. Thirty two bit data from right accumulator 82 may be delivered via 32 bit bus 406 to right LM 28 with destination switch 410 opened, and destination switches 411 and 412 closed.

Still referring to FIG. 4, accumulation of double precision, or double width accumulation will now be described. Since the LM registers are 64 bits wide (for example), a 128 bit live accumulation value in the CPU may be split, or divided, between two 64 bit entries (which may be the size of a vector word). The two entries, in an embodiment of the invention, may be placed in opposite physical registers of left LM 26 and right LM 28. In this manner, the burden of supplying the 128 bit accumulator operand may be shared equally by the two physical LM registers on opposite sides of a single processor core (FIG. 3).

Accordingly, if the result of a previous, incomplete, partial accumulation needs to be reloaded for further accumulation, 64 bits may be supplied to the double width accumulator (accumulator 66 and accumulator 82) from left LM 26 and the other 64 bits may be supplied to the double width accumulator from right LM 28. These two 64 bit entries may be supplied by the third read port, accum, of left LM 26 and right LM 28. In addition, an extra 32 bit wide write pathway may be added to each of the output busses of left and right accumulators 66 and 82, namely busses 402 and 405. In this manner, at the end of an accumulation loop, the double-width (partial) results may be routed from left data path processor 22 and right data path processor 24 to both left and right LMs 26 and 28, respectively.

In operation, for example, four 16 bit data (a, b, c, d), packed into one 64 bit SWP word, are delivered onto the S1 bus from left LM 26. With the L/R S1 switches in position shown, two 16 bit data (a, b) are delivered to multiplier 62 and two 16 bit data (c, d) are delivered to multiplier 78. Concurrently, 64 bit data of a partial accumulation result (for example, A_{H}B_{H}C_{H}D_{H}) are delivered onto the accum bus from left LM 26 and 64 bit data of a partial accumulation result (for example, A_{L}B_{L}C_{L}D_{L}) are delivered onto the accum bus from right LM 28. It will be appreciated that left LM 26 includes the packed high (H) words and right LM 28 includes the packed low (L) words.

When a partial accumulation restarts, the current values of the left and right accumulators are reloaded, before any new partial results are added. By way of the left accum bus, A_{H}B_{H} (32 bits) is delivered to left accumulator multiplexer 415 and C_{H}D_{H} (32 bits) is delivered to right accumulator multiplexer 417. Similarly, A_{L}B_{L} (32 bits) is delivered from right LM 28, via the right accum bus, to left accumulator multiplexer 415 and C_{L}D_{L} (32 bits) is delivered to right accumulator multiplexer 417.

By way of left and right accumulator multiplexers 415 and 417, in the embodiment shown, A_{H}B_{H}A_{L}B_{L} (64 bits) is stored in left latch 416 and C_{H}D_{H}C_{L}D_{L} (64 bits) is stored in right latch 418, respectively. The multiplier operand (for example: a, b) arrives at the input to multiplier 62 concurrently with the partial accumulation value (A_{H}B_{H}A_{L}B_{L}) passing through left accumulator multiplexer 415. The multiplier produces a 64 bit word which is available at the input to left accumulator 66 concurrently with the partial accumulation value also being available at the input to left accumulator 66. After accumulation of both 64 bit words, left accumulator 66 produces a new accumulator value of A_{H}B_{H}A_{L}B_{L}. In a similar manner, right accumulator 82 concurrently accumulates the 64 bit word produced by multiplier 78 with the partial accumulator value (C_{H}D_{H}C_{L}D_{L}) stored in latch 418. After accumulation, right accumulator 82 produces a new accumulator value of C_{H}D_{H}C_{L}D_{L}. The packed accumulator values of A_{H}B_{H}A_{L}B_{L} and C_{H}D_{H}C_{L}D_{L} therefore holds a double precision value with width 128 bits (for example).

The accumulations may continue by feeding back A_{H}B_{H}A_{L}B_{L}, via 64 bit bus 419, to left accumulator multiplexer 415, and feeding back C_{H}D_{H}C_{L}D_{L}, via 64 bit bus 420 to right accumulator multiplexer 417. When a partial or complete accumulation is terminated, however, the packed results may be written (stored) in left LM 26 and right LM 28, via the multiplexing paths shown. Packed high (H) words may be written to the left LM and packed low (L) words may be written to the right LM.

In the example shown, the packed high words (A_{H}B_{H}) on bus 419 are delivered to left LM 26, by way of 32 bit bus 401, the latter being coupled to left 64 bit bus do. The packed low words (A_{L}B_{L}) on bus 419 are delivered to right LM 28, by way of 32 bit bus 402 and left low-result multiplexer 403, the latter being coupled to right 64 bit bus do (with the destination switches, for example, in the positions shown in FIG. 4).

In a similar manner, the packed high words (C_{H}D_{H}) on bus 420 may be delivered to left LM 26, by way of 32 bit bus 406, the latter being coupled to left bus d1 (with the destination switches in the positions shown). The packed low words (C_{L}D_{L}) on bus 420 may be delivered to right LM 28, by way of 32 bit bus 405 and right low-result multiplexer 404, the latter being coupled to right 64 bit bus d1 (with switches in positions shown).

Completing the description of FIG. 4, left low-result multiplexer 403 may also receive 32 low bits produced by multiplier 62 (the 32 high bits may be discarded in single precision) or 32 bits produced by ALU 60. Similarly, right low-result multiplexer 404 may also receive 32 low bits produced by multiplier 78 or 32 bits produced by ALU 80.

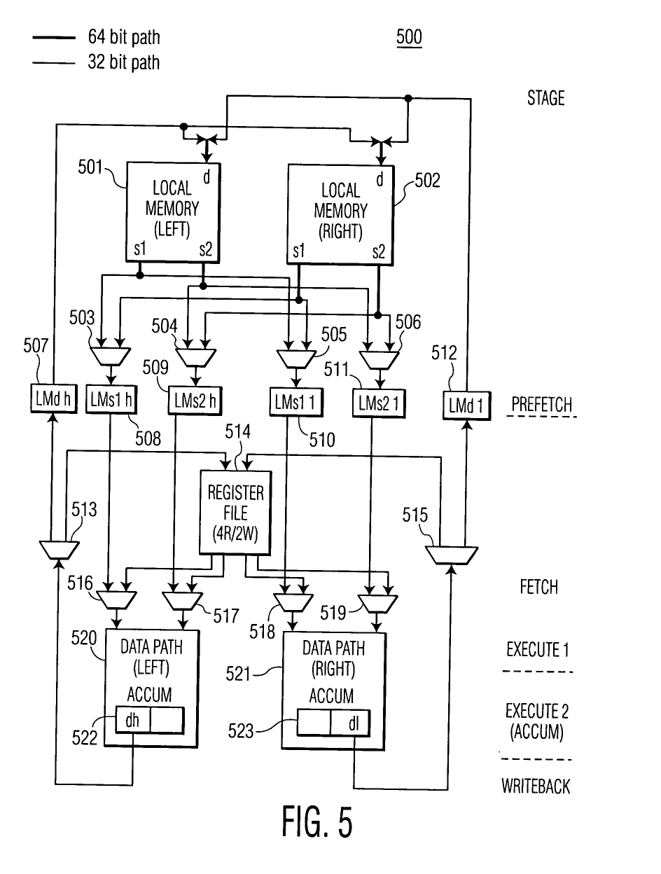

Referring next to FIG. 5, there is shown the clock stages, or cycles, of forwarding, executing and writing back data amongst the left, right LMs (501, 502), register file 514, and the left, right data path processors (520, 521), in accordance with an embodiment of the invention. As shown, CPU 500 includes multiple latches for concurrently latching data during the prefetch cycle (latches 508-511) and concurrently latching data during the writeback cycle (latches 507, 512). Source 1 data (S1) from left LM 501 or right LM 502 is split, via multiplexers 503 and 505, to deliver the high (h) bits into latch 508 (LM S1 h) and the low (l) bits into latch 510 (LM S1 l). Similarly, source 2 data (S2) from left LM 501 or right LM 502 is split, via multiplexers 504 and 506, to deliver the high bits into latch 509 (LM S2 h) and the low bits into latch 511 (LM S2 l).

During the fetch cycle, the high bits (for example) from latches 508, 509 are delivered to left data path processor 520, by way of multiplexers 516, 517. As shown, multiplexers 516, 517 may also fetch source data from register file 514. Similarly, during the fetch cycle, the low bits (for example) from latches 510, 511 are delivered to right data path processor 521, by way of multiplexers 518, 519. As shown, multiplexers 518, 519 may also fetch source data from register file 514.

The next two clock cycles, execute 1 and execute 2, may occur respectively during a first execution (for example a multiply operation) and a second execution (for example, a partial accumulation operation by accumulator 522 in left data path processor 520 and a partial accumulation operation by accumulator 523 in right data path processor 521).

Writeback, which occurs in one clock cycle, delivers the accumulation value in accumulators 522, 523 to left writeback latch 507 (LMd h) and right writeback latch 512 (LMd l), by way of multiplexers 513, 515. In the embodiment shown in FIG. 5, each accumulator 522, 523 delivers 32 bit data to the latches. Accordingly, the writeback latches (507, 512) and the read latches (508-511) are loaded during the same clock cycle. Data from the LMs may, therefore, be loaded into the processor core (22, 24) concurrently with data stored in the LMs.

It will be appreciated that two source operands (S1, S2) may be read (loaded) from, and one destination operand (d) may be written (stored) into each LM, in one clock cycle.

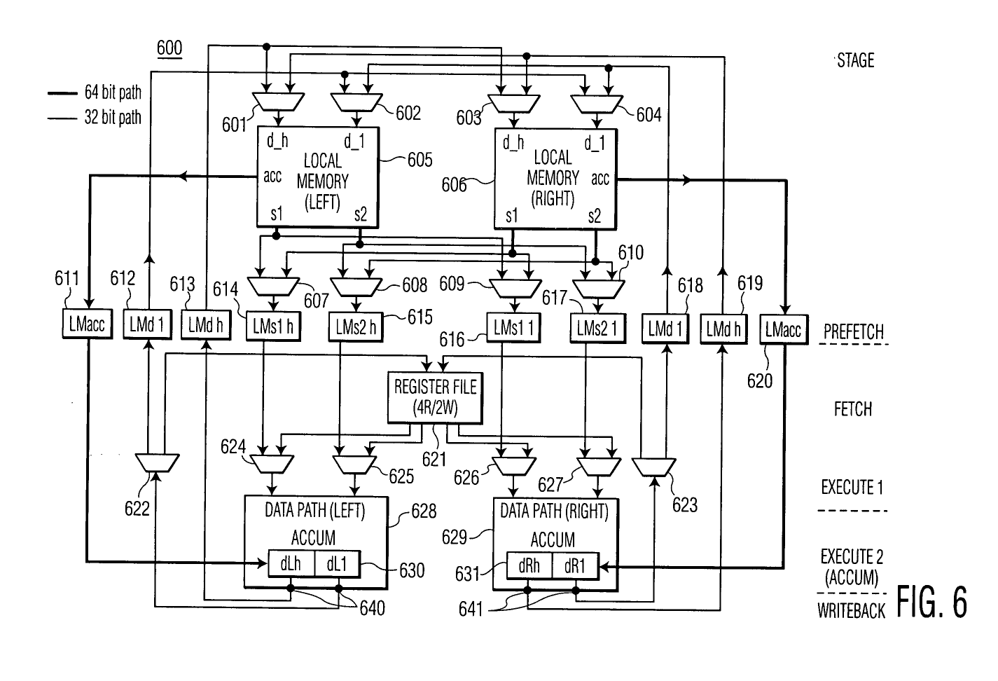

Referring next to FIG. 6, there is shown the clock stages, or cycles, of forwarding, executing and writing back data amongst the left, right LMs (605, 606), register file 621, and the left, right data path processors (628, 629), in accordance with another embodiment of the invention. As shown, CPU 600 includes multiple latches for concurrently latching data during the prefetch cycle (latches 611, 614-617, 620) and concurrently latching data during the writeback cycle (latches 612, 613, 618, 619). Source 1 data (S1) from left LM 605 or right LM 606 is split, via multiplexers 607 and 609, to deliver the high bits into latch 614 (LM S1 h) and the low bits into latch 616 (LM S1 l). Similarly, source 2 data (S2) from left LM 605 or right LM 606 is split, via multiplexers 608 and 610, to deliver the high bits into latch 615 (LM S2 h) and the low bits into latch 617 (LM S2 l). In addition, a third read port (accum), which is provided, respectively, in the left and right LMs, each delivers 64 bits of data into latches 611 and 620 (LM acc) concurrently with the S1 and S2 data during the prefetch cycle.

During the fetch cycle, delivery of the high bits (for example) from latches 614, 615 and the low bits (for example) from latches 616, 617 is provided by multiplexers 624-627. During the execute 1 cycle, an operation, for example multiply, is performed by each of the data path processors. In addition, during the execute 1 cycle, the partial accumulation values from latches 611, 620 are delivered to left and right data path processors 628, 629, so that they are available for accumulation, during the execute 2 cycle, using the result data of the execute 1 cycle.

During the execute 2 cycle, for example, the accumulation is performed by adding the partial accumulation values with the results of the execute 1 operation in accumulators 630, 631. This may produce 128 bit accumulation value, with accumulator 630 delivering 64 bits of packed left data (dL h and dL l) and accumulator 631 delivering 64 bits of packed right data (dR h and dR l).

It will be understood that, for discussion purpose, latches 416, 418 (shown in FIG. 4) are omitted in CPU 600 of FIG. 6. As discussed previously, latches 416, 418 delay the data by one clock cycle, so that the accumulated data arrives concurrently at accumulator 66, 82 with the result data from multipliers 62, 78. In a similar manner, the accumulated data loaded into left and right data path processors 628, 629 are latched during the execute 1 cycle and delivered to accumulators 630, 631 during the execute 2 cycle.

Writeback, which occurs in one clock cycle, delivers a double precision word (128 bits in the exemplary embodiment) to left, right writeback latches 612, 613, 618, 619. Sixty-four bit data (dL h, dL l) are delivered into latches 612, 613 (LMd l, LMd h) and 64 bit data (dR h, dR l) are delivered into latches 618, 619 (LMd l, LMd h). As shown, multiplexers 622, 623 may deliver low 32 bit data (dL l, dR l) into register file 621.

During the prefetch cycle, the partial or final accumulated data (double precision) are delivered for storage into left, right LM 605, 606 by way of multiplexers 601-604. Delivery of data into the LMs may be similar to the delivery of packed data into left LM 26 and right LM 28, discussed previously with respect to the exemplary embodiment of FIG. 4. Accordingly, data may be loaded (read) from the LMs and data may be stored (write) in the LMs during the same clock cycle.

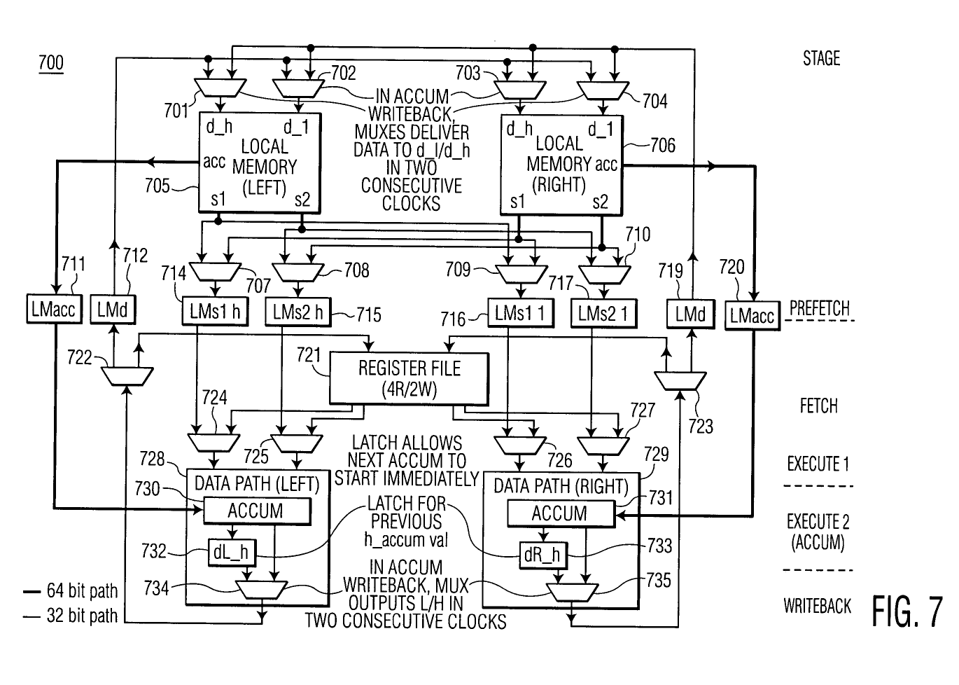

Referring next to FIG. 7, there is shown yet another embodiment of the invention. As shown, CPU 700 includes writeback multiplexers 701-704 delivering data to left, right LMs 705, 706. Included in the writeback paths are multiplexers 722, 723 and writeback latches 712, 719 (LMd). As will be explained, each writeback latch first receives 32 bit low data and next receives 32 bit high data.

As shown, each LM includes three read ports (s1, s2, accum) delivering data concurrently into latches 711, 714, 715, 716, 717 and 720 (left LM acc, LMs1 h, LMs2 h, LMs1 l, LMs2 l, and right LM acc, respectively). Source 1 (S1) or source 2 (S2) data may be delivered, as shown, via multiplexers 707-710, into latches 714-717. Additional multiplexers included in the load (read) paths are multiplexers 724-727, which deliver data, during the fetch cycle, from either the prefetch latches or register file 721 to left, right data path processors 728, 729.

The load operation between the LMs and the left, right data path processors during prefetch, fetch, execute 1 and execute 2 clock cycles are similar to the load operation discussed with respect to FIG. 6. The writeback (or store) operation, however, is different, and is discussed below.

In order to save on wire, the second 32 bit writeback port is eliminated in the embodiment of FIG. 7 (note difference of the two 32 bit writeback ports, 640-641 in FIG. 6, or dual busses 401-402 and 405-406 in FIG. 4). The effect of removing this port is felt, when it is necessary to writeback a 128 bit datum from accumulators 730, 731 to the pair of LMs, each having only 64 bit registers.

On the clock cycle when the entire 128 bit datum may be written back in the embodiment of FIGS. 4 and 7 (for example), only the low half word is written back into latches 712, 719, by way of multiplexers 734, 735 and multiplexers 722, 723. The high half word is saved in left, right latches 732, 733 (dL h, dR h). At the end of this clock cycle, accumulators 730, 731 are empty and ready to begin a new round of accumulation (similar to the complete architecture). As long as the new accumulation takes longer than one clock cycle, the writeback of the high half word in the subsequent clock cycle uses the idle d-port to complete the writeback. Of course, multiplexers at the CPU output and the LM input must be correctly switched to place the high and low data correctly (as shown, for example, in FIG. 4).

If a subsequent instruction produces a result on the very next clock cycle, however, the architectural change causes a one-clock cycle stall. Without this stall, the writeback of the high half word occurs simultaneously with the writeback of the result of the one-clock cycle subsequent instruction.

It will be appreciated that, in the embodiment shown in FIG. 7, the low half word is chosen to be written back first, because the low word is the only word needed to be written in a single precision writeback case. Hence, in such case, the high latch (732, 733) is unused and the mux (734, 735) stays in the low state.

It will be further appreciated that source address(es) are sent to the LMs to fetch data. The data from the LMs return as far as the latches between the data path processors and the LMs (for example latches 614-617 in FIG. 6). The opcode and any internal register file (621) operand address are buffered (not shown) for one clock cycle in order to synchronize with data coming from the LMs. If the destination addresses are in the LM, they are buffered (not shown) for two clock cycles, again, to synchronize with result data being written back from the latches to the LMs.

In other words, there is a one clock cycle bubble to fetch data from a LM. In a vector operation, this penalty is paid only once per vector. In a series of vector operations that may be placed back-to-back, the penalty is paid once per series of vector operations. Such bubbles are called startup latencies or setup time, and are known in vector CPU architectures.

During an execute clock cycle (for example execute 1) data from the latches enter the left, right data path processors and are processed by the instruction that was buffered. Result data may be written back (assuming no execute 2 cycle) as far as the latches between the data processors and the LMs (for example latches 612, 613, 618, 619). The result data from the latches are written to the LMs during the next clock cycle, using the addresses that were buffered for two clock cycles.

In the embodiment of FIG. 7, another clock cycle is used to writeback the second half word into the LMs. As a result, the destination addresses used in the previous clock cycle are latched and reused.

From a programmer's point of view, it is necessary to provide multiple “live” accumulators, which are needed to minimize redundant accesses of DRAM memory. This is accomplished by allowing the computation of multiple partial results on a data set before overwriting the partial sources in the LM with new streaming data from DRAM memory.

The instruction set architecture (ISA) may include a single precision (N bits) vmac (vector multiply and accumulate) instruction and a double precision (2N bits) vmac, or vmacd. Both single and double precisions use the packed format previously discussed.

The instruction syntax in a SPARC ISA for a vector multiply and accumulate may be as follows:

vmac[d] src1, src2, accumLMreg (where srcN can be {LMreg, CPUreg, FIFO})

This syntax may be chosen, rather than separating the loading of the accumulator into a different instruction. Such a separation may create an external state. Also, this syntax may inform the CPU that the accumulated result is to be written back to accumLMreg., i.e., the programmer names a specific LM register as the destination for the result of the accumulation. That eliminates a separate instruction for storing. This syntax allows back-to-back vmac[d] instructions to proceed without any clocks wasted for moving partially or completely accumulated results. Any loop overhead would be a burden, given the short length of LM-based vectors. (For example, a block DCT code has a loop count of 2.)

Since vmac[d] is only concerned with accumLMreg, the physical implementation of the CPU accumulator is architecturally-invisible to the ISA.

The vmacd syntax implies that, before the accumulation begins, a 128-bit value (for example) specified by accumLM-reg, is pre-loaded into the accumulator. Since the LM registers are 64-bits (for example), something special happens in the vmacd case. As previously discussed, each LM-stored 128-bit live accumulator value is split between two 64-bit entries (the vector word size), and the two entries are placed in opposite physical banks (left and right) of the LM. This placement assures that the burden of supplying the 128-bit accumulator operand is shared equally by the two physical LM register banks of a single CPU. As an example, if accumLMreg is specified as LM32, then 64 bits are loaded into the accumulator from LM32, and the other 64 bits are loaded from a corresponding LM register on the opposite side of the CPU (or processor core), e.g., LM96. It should be understood that a virtual naming scheme for LM registers, is being used.

For vector operations, each LM has three 64-bit ports to the CPU (or processor core), two read ports and one write port. But, for the first clock cycle of a vmac or vmacd, a third value is read; and, in the vmacd case, that third value is a 128-bit value, or the accumulator value. This third value is preloaded into the accumulator, and arrives concurrently with the multiplier operands. As a result, the third value is available to take part in the first cycle of accumulation.

At the end of a vmacd loop, the final accumulated result may be written out, to the same pair of related LM registers, via the single write port of both LM physical register banks. No extra write ports are needed. Due to latency, the accumulated result may arrive one clock after the vmac[d] loop ends. But, this latent write-out does not interfere with the read-in of three operands for a back-to-back vmac[d].

In the case of single precision (i.e., vmac), space in the LM only needs to be reserved for the low half of the accumulators. The routing of the high half may be disabled, as may be the upper half of the 64-bit accumulator.

Due to the pipelined architecture of the system, multiply-accumulate instructions may be executed back-to-back with no stalls to re-load/re-store a partial result. The invention allows completion of all partial processing on a moving window with no overhead for transfer to/from the accumulator. The invention does not incur a penalty for fetching a live partial accumulation value. From a programmer's point of view, the processor appears to have multiple double-width accumulators. Each such accumulator occupies similarly placed registers in both halves of the LM. The SWP precision and performance doubling provided by the double-width accumulator is worth the cost of the third read port in the left and right LMs.

It will appreciated that a conventional processor would need to add the equivalent of two extra read ports, instead of one. That is because a conventional processor has a single register file, whereas the invention has two half LMs and forces the double width accumulator values to be split across the two half LMs.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

What is claimed:

1. A processing system comprising:
left and right data path processors configured to concurrently receive parallel instructions,
left and right accumulators, respectively, disposed in the left and right data path processors, configured to execute an accumulate instruction and obtain an accumulation value, and
left and right local memories (LMs) coupled to the left and right accumulators configured to store the accumulation value,
wherein the accumulation value is divided for storage in the left LM and the right LM.

2. The processing system of claim 1 wherein the accumulation value includes a first value obtained by the left accumulator and a second value obtained by the right accumulator, and
the first value is divided for storage in both the left LM and the right LM, and the second value is divided for storage in both the left LM and the right LM.

3. The processing system of claim 2 wherein the first and second values include packed high words and packed low words, and the packed high words are stored in the left LM and the packed low words are stored in the right LM.

4. The processing system of claim 1 including a left accumulator read port in the left LM and a right accumulator read port in the right LM for delivering the equally divided accumulation value, respectively, to the left and right accumulators.

5. The processing system of claim 4 including source operand read ports in the left LM and the right LM for delivering operand values to at least one of left and right multipliers, in which the left and right multipliers are configured to execute multiply operations in a first clock cycle, and
at least one of the left and right accumulators configured to accumulate a multiplied result value, provided by one of the left and right multipliers, onto the equally divided accumulation value in a second clock cycle.

6. The processing system of claim 5 wherein the equally divided accumulation value is stored in at least one of the left and right LMs in a third clock cycle.

7. The processing system of claim 5 wherein the equally divided accumulation value is stored in at least one of the left and right LMs in a duration of two clock cycles.

8. A method of accumulating data in a processing system comprising the steps of:
(a) concurrently receiving parallel instructions;
(b) obtaining an accumulation value in an accumulator in response to the received parallel instructions;
(c) dividing the accumulation value into a first value and a second value; and
(d) concurrently storing the first value in a left local memory (LM) and the second value in a right LM.

9. The method of claim 8 including the step of:
(e) returning both the stored first value in the left LM and the stored second value in the right LM to the accumulator to obtain another accumulation value.

10. The method of claim 9 in which step (e) includes returning the stored first value to a left accumulator and returning the stored second value to a right accumulator,
whereby the left accumulator and the right accumulator perform separate accumulations.

11. The method of claim 9 including the step of:
(f) delivering a result value of an executed instruction to the accumulator; and
step (e) includes returning both the stored first value and the stored second value to the accumulator concurrently with delivering the result value in step (f) to obtain the other accumulation value.

12. The method of claim 8 in which step (c) includes dividing the accumulation value into packed words of high and low values, and
step (d) includes concurrently storing packed words of high value in the left LM and storing packed words of low value in the right LM.

13. The method of claim 12 in which step (d) includes storing the packed words in one clock cycle.

14. In a processing system including left and right data path processors sharing an internal register file, and left and right external local memories, a method of accumulating data comprising the steps of:
(a) fetching and storing an operand into an operand latch;
(b) fetching and storing a partial accumulation value into an accumulation latch;
(c) delivering the operand from the operand latch into the left data path processor and the right data path processor;
(d) executing an operation using the delivered operand to obtain a result;
(e) delivering the partial accumulation value into the left data path processor and the right data path processor; and
(f) concurrently executing a left accumulation in the left data path processor and a right accumulation in the right data path processor using the result obtained in step (d) and the partial accumulation value delivered in step (e).

15. The method of claim 14 including the steps of:
(g) after executing step (f), dividing a left accumulation value produced by the left accumulator into left high and low bits, and dividing a right accumulation value produced by the right accumulator into right high and low bits; and
(h) writing back the left high bits and the right high bits, respectively, into the left external local memory, and writing back the left low bits and the right low bits, respectively, into the right external memory.

16. The method of claim 15 in which step (h) includes writing back the left and right, high and low bits, respectively, into the left and right external local memories in the same one clock cycle.

17. The method of claim 15 in which step (h) includes writing back the left high and low bits into the external local memories in two clock cycles, and
writing back the right high and low bits into the external local memories in the same two clock cycles.

18. The method of claim 14 in which step (a) includes fetching and storing the operand from at least one of the left and right external local memories during one clock cycle, and step (b) includes fetching and storing the accumulation value from the at least one local memory during the same clock cycle.

19. The method of claim 14 including the step of:
(g) writing back a double precision word from the left and right data path processors into the left and right external local memories, in which a first portion of the double precision word is written back into the left external memory and a second portion is written back into the right external memory; and
step (e) includes fetching from the left and right external memories a value of the first portion and a value of the second portion, respectively, into the left and right data path processors,
whereby the values of the first and second portions is the partial accumulation value.

20. The method of claim 14 in which the partial accumulation value includes multiple high and low value data items, and
step (e) includes fetching from the left external memory multiple high value data items to the left and right data path processors, and
fetching from the right external memory multiple low value data items to the left and right data path processors; and
step (f) includes writing back from the left data path processor multiple high value data items to the left external memory and multiple low value data items to the right external memory, and
writing back from the right data path processor multiple high value data items to the left external memory and multiple low value data items to the right external memory.
